(19) United States
(12) Patent Application Publication
(10) Pub. No.: US 2005/0066781 A1
(43) Pub. Date: Mar. 31, 2005

(54) Method and apparatus for trimming printed products

(76) Inventor: Kurt Begemann, Loehne (DE)

Correspondence Address: ALIX YALE & RISTAS LLP, 750 MAIN STREET, SUITE 1400, HARTFORD, CT, 06103, US

(21) Appl. No.: 10/872,278

(22) Filed: Jun. 18, 2004

(30) Foreign Application Priority Data
Jun. 27, 2003 (DE) 103 29 119.9
Apr. 1, 2004 (DE) 10 2004 016 107.0

(51) Int. Cl. B26D 1/00

(52) U.S. Cl. 83/13; 83/49; 83/218

(57) ABSTRACT

For a method for trimming printed products 2, such as book blocks, brochures and the like with the aid of a tractive knife cut, in which the printed products 2 are moved against a stationary knife 17, it is proposed that the cutting process takes place in two successive operations, the edge of the printed product 2 to be trimmed being cut off in a first operation by a precut 13 extending close to the final trimming dimension and being finally trimmed in a second operation by a smoothing or final trimming cut 16 by means of the tractive knife cut. The apparatus for implementing the method includes a conveying system 10, 11 for retaining and guiding the printed products 2 in a clamped state at least during the cutting process, and a first cutting station 13 with a rotationally driven cutting tool 15 for precutting and a second cutting station 16 with a stationary knife 17 for smooth final trimming. The two cutting stations 13, 16 and the conveying system 10, 11 are combined in a compact cutting module 9, 26, 27.

### BACKGROUND OF THE INVENTION

The present invention relates to a method and an apparatus for trimming printed products.

For trimming printed products, in particular bound book blocks, brochures and the like, three-knife trimmers which trim the printed products on the three non-bound sides are known, the printed products being fixed on a stationary trimming table by a press ram and side knives trimming the head and tail edges and a transverse knife trimming the front edge successively. The cuts are made using a diagonal rocking cut against a cutting rail, also known as the knife-edge-and-anvil principle on the stationary product, and permit high-quality cutting even of thick printed products. DE 28 52 878 C2 shows a three-knife trimmer having hypocycloidal motions of the side knives, making possible almost simultaneous cutting motions of the side knives and transverse knife for trimming.

By performing all the cuts in a pressed position, shifting of the printed products through temporary removal of pressure or transportation is avoided and high dimensional stability is achieved. As a result of the fact that the product is stationary during trimming, in conjunction with feeding, alignment, pressing and ejection of the printed products, the cycling rate is limited in the case of three-knife trimmers. Higher cutting performance, as required by adhesive binding conveyor lines, is achieved by stacking—which incurs not inconsiderable complexity and cost for stacking, and for unstacking when the individual products must be processed after the three-side trimming. Because of the use of format-dependent interchangeable parts (cutting table, pressing ram), a setting-up time is required when changing format.

Trimmers which operate according to the shear cutting principle are also known for three-side trimming, and are characterised in that an upper knife is moved against a fixed lower knife. Side and front trimming are carried out in two spatially separate stations. Only limited cutting quality is achievable and the maximum operating height is restricted to approx. 15 mm. Trimmers of this kind are suitable for individually trimming periodicals and thin brochures and achieve high cutting performance.

The shear cutting principle is also used in rotary trimmers in which the printed products pass in an imbricated formation through two cutting stations arranged at right angles to one another and coupled by a corner module for re-orienting the printed products. In this case the cuts are made by rotating upper knives which move against likewise rotating lower knives. The printed products to be cut are conveyed through the cutting stations while being retained by pressing belts. Extremely high cutting performance is made possible by rotary trimmers. However, because of the shear cutting principle with rotary knives, they are not suitable for high-quality three-side trimming.

A further principle for trimming printed products results from the knife-edge-and-anvil method using a stationary knife against which the clamped printed products are moved. Known from EP 0 670 203 B1 is an apparatus in which, to reduce the not inconsiderable cutting forces, a plurality of cutting edges are provided which act successively on the edge of the printed product to be trimmed. However, the magnitude of the necessary retaining forces still requires the printed products to be clamped to a clamping carriage, so that timed feeding and ejection of the printed products are unavoidable with this apparatus.

### SUMMARY OF THE INVENTION

It is the object of the present invention to provide a method for trimming printed products and an apparatus for implementing the method, which method and apparatus allow individual products fed in an untimed manner to be trimmed with high quality and high cutting rates.

This object is achieved according to the invention in that the cutting process is carried out in two successive operations, the edge of the printed products to be trimmed being precut to a dimension close to the final trimming dimension in a first operation and the final trim being performed in a second operation by a smoothing or finishing cut using a tractive knife cut. It has proved especially advantageous to carry out the precut with a rotating tool, the edge to be trimmed being processed as far as possible by machining, e.g. by milling or sawing, and to remove only a very thin sliver, preferably approx. 0.5 mm thick, in the smoothing or finishing cut.

The inventive concept consists in first precutting the printed products using a cutting method which is independent of the trimming dimension and uses low cutting forces, the printed products then being cut smooth using a tractive knife cut which removes a thin sliver of material. Because only a small volume of paper must be forced aside during the second cut only low cutting forces are needed, which forces, moreover, are highly independent of the relative drawing speed of the knife and increase only insignificantly with relatively large product thicknesses. The cutting method is therefore also suitable for trimming thick printed products and makes possible high cutting performance.

It is advantageous for the printed products to be held continuously while being transported during the cutting process, including the precut and smoothing or final trimming. Because of the low cutting forces in comparison to previously known cutting methods, it is sufficient, according to a preferred embodiment, to clamp the printed products between endless conveyor means, such as pressing belts, roller chains with clamping plates, toothed belts or the like, for transportation during the cutting process. Additional clamping means, such as pressing rams and cutting tables moving synchronously with the printed products, are not required, so that format-dependent interchangeable parts do not need to be exchanged when changing format. The cutting method can be employed such that the printed products are movable against the cutting tools in an untimed manner. The cutting method can also advantageously be used for trimming printed products fed in an imbricated flow.

The cutting method according to the invention can be used for three-side trimming. In the cutting method for processing the spines of book blocks during adhesive binding, the back margin of the assembled folded sheets is cut off. This cutting off is followed by roughening and notching of the spine of the book block.

The apparatus for implementing the cutting method can include a cutting module comprising a first cutting station including a rotationally driven cutting tool for precutting, and a second cutting station including a stationary knife for the smooth final trimming.

### BRIEF DESCRIPTION OF THE DRAWINGS

The invention is described in detail with reference to a three-knife trimmer depicted in the drawings, in which:

FIG. 1 shows the three-knife trimmer in a top view;

FIG. 2 shows the precutting station and the final trimming station for the front trimming cut in a side view according to the viewing definition II-II in FIG. 1;

FIG. 3 shows a section through the precutting station and the final trimming station for head and tail trimming according to the cutting sequence III-III shown in FIG. 1.

### DESCRIPTION OF THE PREFERRED EMBODIMENT

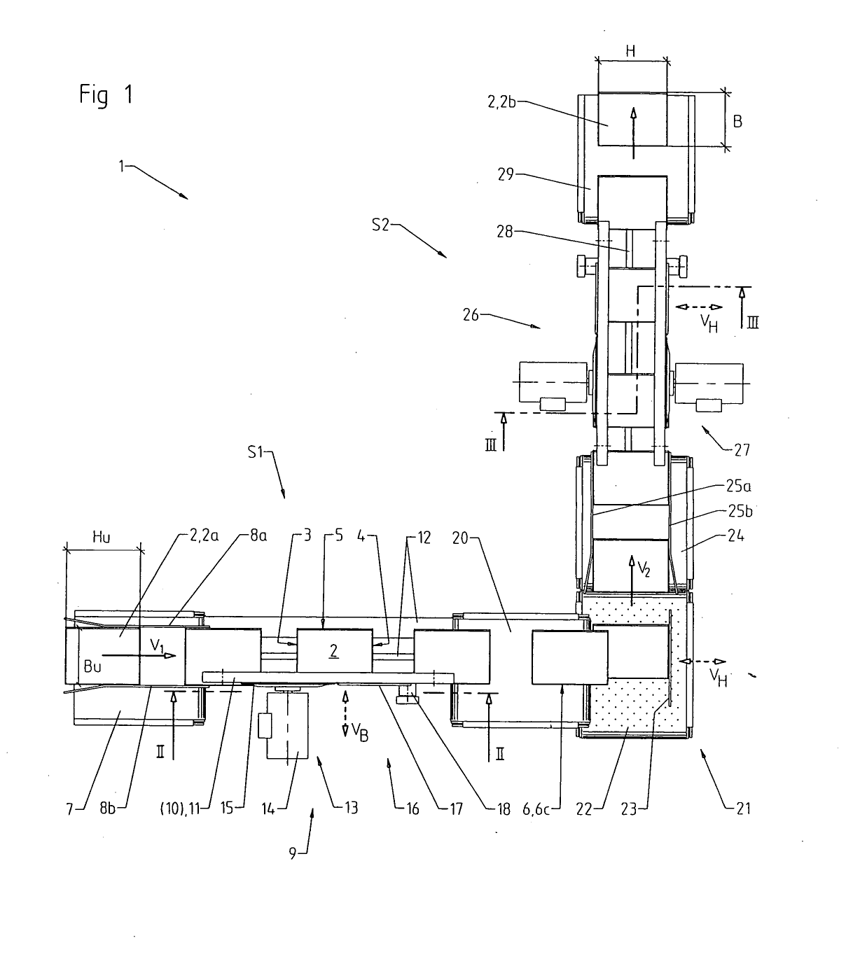

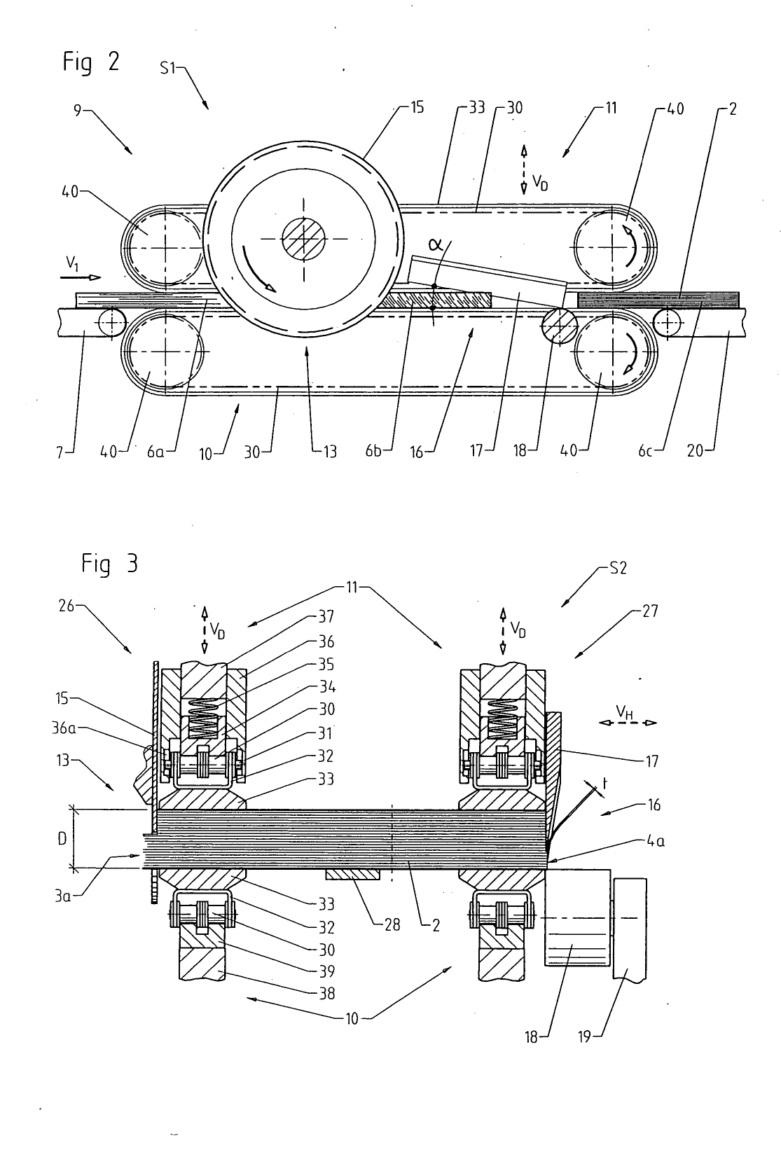

FIGS. 1 and 2 show the three-knife trimmer 1 for book blocks 2 executed according to the inventive cutting method, comprising two cutting units S1 and S2 arranged at right angles to one another, cutting unit S1 being equipped with a cutting module 9 for the front trimming cut and cutting unit S2 being equipped with two cutting modules 26 and 27 for the head and tail trimming cuts. The book blocks 2 are transported through the cutting units S1, S2 while lying flat.

Each of these cutting modules 9, 26, 27 comprises a lower and upper press plate chain conveyor 10, 11 respectively for clamping and continuously conveying the book blocks 2 from a first cutting station, the precutting station 13 which has a rotationally driven saw blade 15 for precutting, and a second cutting station, the final trimming station 16, which has a fixed knife 17 for subsequent smooth final trimming of a lateral face of an individual book block.

Each book block 2 has a head edge 3, a tail edge 4, a spine 5 and a front edge 6 and is bound along the spine 5. The untrimmed book blocks 2a have a height Hᵤ and a width Bᵤ. After trimming on the three unbound sides, i.e. the head edge 3, the tail edge 4 and the front edge 5, the height H and the width B of the finally trimmed book block 2b are produced.

For front trimming the untrimmed book blocks 2a are fed on a conveyor belt 7 while being aligned by lateral guides 8a,b of cutting unit S1 at a feed velocity v₁ and are conveyed onwards while being clamped close to the desired cutting edge by the press plate chain conveyors 10, 11. The unclamped part of the book block 2 is supported by support rails 12. The untrimmed front edges 6a of the book blocks 2 move into the range of action of the saw blade 15, which is driven in rotation by a motor 14, at least the uneven edge portion of the book block 2 being removed to produce a level side face. While continuing to be conveyed in the clamped state the book blocks 2 are then fed with their precut front edge 6b to the knife 17, which is arranged at a fixed cutting angle α, for execution of the smooth final trimming. According to the inventive concept only a thin sliver of up to about approx. t=0.5 mm is removed. So that the last page is also securely trimmed, the knife 17 is set with respect to a freely rotating support roller 18 pivoted in a bracket 19.

The book blocks 2 with finally trimmed front edges 6c are delivered to a conveyor belt 20 and conveyed onwards, via a corner module 21 consisting of a suction belt conveyor 22 and a stop rail 23, transversely to the original transport direction at a transport velocity v₂ for transfer to a conveyor belt 24, which laterally aligns the book blocks 2 with guide rails 25a,b and feeds them to the second cutting unit S2.

In the second cutting unit S2 each book block 2 is clamped along its head edge 3 and tail edge 4 by press plate chain conveyors 10, 11 and conveyed onwards. The cutting processes for head and tail trimming are carried out in the same way as for front trimming. It can be seen in FIG. 3 how the uneven, uncut head edge 3a is severed by the saw blade 15 in the precutting station 13 and the precut tail edge 4a is finally trimmed by the fixed knife 17 in the final trimming station 16. During transportation through the cutting unit S2 the book blocks 2 are supported by a support rail 28 located centrally between the press plate chain conveyors 10, 11. After trimming in the cutting unit S2 the finished, trimmed book blocks 2a are transferred to a conveyor belt 29 and fed to further-processing devices.

In FIG. 3 the construction of the press plate chain conveyors 10, 11 can also be seen. The lower press plate chain conveyor 10 is formed by a driven roller chain 30 circulating around chain-wheels 40, which roller chain 30 bears against a chain guide 39 fixed in a frame-mounted bracket 38 in the area of clamped transportation. U-shaped brackets 32 which are able to receive press plates 33 are attached to the individual links of the roller chain 30. The book blocks 2 rest on the press plates 33 of the lower press plate chain conveyor 10 and are clamped with a defined retaining force by the press plates 33 of the similarly constructed upper press plate chain conveyor 11. To generate the retaining force the associated chain guide 34 is guided between guide plates 36 and bears against a frame-mounted support 37 via compression springs 35. The roller chain 30 with the attached press plates 33 is thereby pressed downwardly, the displacement travel being limited by projecting pins 31 of the roller chain 30 in correspondingly formed grooves 36a of the guide plates 36.

The upper press plate chain conveyors 11 are adjustable to the thickness D of the book blocks 2 by means which are not illustrated in detail. In FIGS. 2 and 3 this adjustment V_{D} is represented by a broken double arrow. Further adjustments are provided to take account of the width B and the height H of the book blocks 2. Thus, in cutting unit S1 the cutting module 9 is adjusted using adjustment V_{B} with respect to width B in such a way that the spine 5 is guided along a constant line. In cutting unit S2 the cutting module 27 for tail trimming is adjusted with respect to the height H of the book blocks 2. This adjustment V_{H} is also provided for the stop rail 23 of the corner module 21.

The three-knife trimmer 1 for book blocks 2 executed according to the inventive cutting method does not require timed flows of products, making possible cost-effective construction—in particular, because similarly constructed cutting modules 9, 26, 27 are used. In addition to high cutting performance, the three-knife trimmer 1 is distinguished by the fact that relatively large (product) thicknesses D can be processed. Alternatively to the configuration illustrated, the cutting units S1, S2 may be used at different locations or in different phases of further printing processing. For example, cutting unit S1 could be used directly downstream of an adhesive binding machine, upright transportation of the book blocks 2, as in the adhesive binding machine, being possible. The cutting unit S2 would follow only after a drying conveyor line. Moreover, the cutting process for the front trimming cut 9 may be carried out in the adhesive binding machine itself, the book blocks 2, which are conveyed while held in transport clamps, being first moved past a saw blade 15 or milling tools for the precut 13 and then past a stationary knife 17 for the final trimming cut 16.

1. A method for trimming a printed product comprising the steps of:
transporting the printed product to a pre-cutting station;
pre-cutting, with a first cutter, one edge of the printed product to an unfinished dimension;
trimming, with a tractive knife cutter, the one edge of the printed product to a finished dimension.

2. The method of trimming a printed product according to claim 1, wherein the first cutter is a rotating tool.

3. The method of trimming a printed product according to claim 1, wherein the first cutter is a machining device.

4. The method of trimming a printed product according to claim 1, wherein the step of trimming includes removing a few tenths of a millimetre of material from the printed product.

5. The method of trimming a printed product according to claim 1, wherein the step of trimming removes about 0.5 mm thickness of material from the printed product.

6. The method of trimming a printed product according to claim 1, wherein during the pre-cutting and the trimming steps the printed product is constantly retained and guided by conveyor means.

7. The method of trimming a printed product according to claim 6, wherein the printed product is conveyed while clamped between pressing belts, roller chains with clamping plates, or toothed belts.

8. The method of trimming a printed product according to claim 1, wherein the printed product is transported in an untimed manner.

9. The method of trimming a printed product according to claim 1, wherein the printed product is trimmed in an imbricated flow.

10. The method of trimming a printed product according to claim 1, wherein the product has a head end, a tail end, and a front end and said pre-cutting and trimming of said one edge is at the front end including the steps of:
transporting the printed product having the trimmed front end to a second pre-cutting station;
precutting the head end of the printed product, with a second cutter, to an unfinished head end dimension, and pre-cutting the tail end of the printed product with a third cutter to an unfinished tail end dimension;
trimming the head end of the printed product, with a second tractive knife cutter, to a finished head end dimension, and trimming the tail end of the printed product with a third tractive knife cutter to a finished tail end dimension.

11. The method of trimming a printed product according to claim 1, wherein the printed product is a book block having a spine, and the steps of pre-cutting and trimming are performed on the spine of the book block during adhesive binding.

12. The method of trimming a printed product according to claim 11, wherein the spines of the book blocks are roughened after trimming.

13. A printed product trimmer comprising:
a transport assembly for clamping and guiding printed products;
a cutting module for cutting an edge of a clamped and guided printed product, said cutting module having a first cutting station which includes a rotationally driven cutter tool, and a second cutting station which includes a stationary knife.

14. The printed product trimmer of claim 13, wherein the cutting tool of the first cutting station is a milling cutter or saw blade.

15. The printed product trimmer of claim 13, wherein a support roller is associated with the stationary knife.

16. The printed product trimmer of claim 13, wherein the transport assembly includes an upper and a lower transport means, which transport means extend over the pre-cutting and trimming stations and between which transport means the printed products are conveyed while clamped at least on the edge portions to be trimmed.

17. The printed product trimmer of claim 13, wherein the upper and the lower transport means are selected from pressing belts, roller chains with clamping plates, or toothed belts.

18. The printed product trimmer of claim 13, wherein
said cutting module is upstream in a feed direction from a second cutting module and a third cutting module;
said second module has a second cutter and a second tractive knife and said third cutting module has a third cutter and a third tractive knife, said second and third cutting modules being arranged parallel to one another;
a reorientation conveyor intermediate said cutting module and the second and third cutting modules serving to reorient the printed product such that a second edge of the printed product is precut and trimmed by the second cutter and the second tractive knife and a third edge of the printed product is precut and trimmed by the third cutter and the third tractive knife.
